(19) United States
(12) Patent Application Publication
(10) Pub. No.: US 2016/0006628 A1
(43) Pub. Date: Jan. 7, 2016

(54) DETERMINING GEO-LOCATIONS OF USERS FROM USER ACTIVITIES

(71) Applicant: Mailin Sherl, Zurich (CH)

(72) Inventors: Fiona Herring, London (GB); Krzysztof Duleba, Pfaffikon (CH); Giorgio Scherl, Ebikon (CH); Luuk van Dijk, Zurich (CH); Zoltan Szamonek, Zurich (CH)

(73) Assignee: GOOGLE INC., Mountain View, CA (US)

(21) Appl. No.: 13/458,895

(22) Filed: Apr. 27, 2012

Related U.S. Application Data
(60) Provisional application No. 61/481,704, filed on May 2, 2011.
(60) Provisional application No. 61/481,696, filed on May 2, 2011.

(51) Int. Cl. H04L 12/26; H04L 29/12

(52) U.S. Cl. CPC H04L 43/065; H04L 61/2007

(57) ABSTRACT

Methods, systems, and apparatus, including computer programs encoded on computer storage media, for determining geo-locations of users from user activities. One of the methods includes obtaining information associated with multiple client devices located at multiple geographic locations; identifying a group of client devices based on network addresses assigned to the client devices; obtaining a prediction that the client devices are in a first geographic location; and determining a probability distribution that the client devices are distributed across multiple locations including or adjacent to the first geographic location.

### CROSS-REFERENCE TO RELATED APPLICATIONS

Under 35 U.S.C. §119, this application claims benefit of pending U.S. Provisional Application Ser. No. 61/481,704 and U.S. Provisional Application Ser. No. 61/481,696, both filed May 2, 2011, the entire contents of which are hereby incorporated by reference.

### BACKGROUND

This specification relates to clustering network devices by network addresses and/or determining geographic locations of network devices.

Network devices in particular include client devices that can be operated by one or several users. Client devices (for example, computer systems) that are coupled to a network (for example, the Internet) enable users of the client devices to access resources stored on host computers that are also coupled to the network and on which the resources are stored. A network service provider, for example, an Internet Service Provider (ISP), can assign network addresses (for example, Internet Protocol (IP) addresses) to client devices that serve to identify each client device. For example, when a request to access a resource is received from a client device, the network address is used, among other things, to route the requested resource from a host that stores the resource to the client device.

Different network devices can be physically located at different geographic locations (or “geo-locations”) distributed across the world. The task of assigning network addresses to all client devices within a given geographic area can be delegated to a network service provider, for example, an ISP, that services that area.

### SUMMARY

This specification describes technologies relating clustering network devices based on similarities in network address allocation patterns, and determining the geo-location of network devices from events received from clustered sets of network devices.

Particular implementations of the subject matter described in this specification can be implemented to realize one or more of the following advantages. The techniques described here can be used to build a system that can identify groups of network devices that are likely located in the same or nearby geographical locations, and in addition or alternatively can be used to infer a distribution of geographical locations of network devices (e.g., client devices) from events associated with those devices (i.e., patterns of information, obtained from the network devices). For example, an estimate of a geographical location of a client device can be inferred from information obtained from an aggregated group of client devices that are located in or near the same geographical area, for example, on the order of 1000 devices that is stable on a timescale of one day, and the location can be accurate to the level of a city or a postal code (for example, a 2×2 sq. km area). Further, upon receiving or determining a location probability distribution for a client device, a system can personalize the experience of a user of the client device, for example, by providing resources including advertisements and search results that are relevant to the geographical locations in the location probability distribution.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows multiple network devices and computer systems coupled to a network.

FIG. 2 is a flow diagram of an example process for determining probability distributions that network devices are distributed across multiple geographic locations.

FIG. 3 is a flowchart of an example process for determining a probability distribution that provides the probability that a network device having a given IP address is located at any one of multiple geographic locations.

FIG. 4 is a flowchart of a process for improving a probability distribution that provides the probability that a network device having a given IP address is located at any one of multiple geographic locations.

FIG. 5 is a flow diagram of an example process for determining a probability distribution of geographical locations of a device or a group of devices

Like reference numbers and designations in the various drawings indicate like elements.

### DETAILED DESCRIPTION

In the context of the Internet, multiple network devices (for example, desktop computers, laptop computers, personal digital assistants, or smartphones) can be used to access resources (for example, web pages, text, images, audio, or video) stored on computer systems (for example, web servers). In one example, the network devices and the computer systems form a client-host-system, so that the network devices function as client devices and the computer systems function as host systems.

The network devices are assigned network addresses by which they can be identified. A network address can be an Internet Protocol version 4 (IP) address, an IP version 6 (IPv6) address, an Internetwork Packet Exchange (IPX) address, or other suitable address. Often, an IP address of a network device can be used to cluster a network device in a group of devices which probably are located in a similar geographical location and/or to estimate the geographic location in which the device is located.

The term “geographical location” refers to any kind of identifier suitable to identify the location of a network device. For instance, a geographical location can be a country, a state, a city, a ZIP code area or a street or an address. In other examples, a geographical location can be a point of interest, for example a building. In still other examples, a geographical location can be a coordinate pair or a coordinate triplet identifying a point on a map, for example a latitude/longitude pair.

IP addresses assigned to network devices (e.g., client devices) that are located in the same geographic location are likely to share similarities. For example, IP addresses assigned to network devices located in the same geographic location (e.g., a town or neighborhood) are likely to be assigned from a common range of IP addresses. IP addresses can be interpreted to have a routing prefix part and a host address part. In a class C IP address, the first 24 bits are the routing prefix or subnetwork address; the remaining eight bits, the host address. Network addresses within a particular subnetwork address range are typically allocated statically or dynamically by a local and/or regional network service provider, for example, an ISP. Thus, the network address assigned to a particular network device can vary over time as the addresses within the subnetwork range are dynamically allocated to different network devices by the ISP. Consequently, an estimation of a geographic location of a network device based on the entire network address assigned to the device (i.e., the subnetwork address and the host address) has limited reliability.

An ISP typically assigns a range of network addresses, defined by a subnetwork address, to network devices in the same geographic location. Thus, an estimation of a geographic location of a network device based on the subnetwork address or routing prefix assigned to the network device provides a more useful indication of the location of the network device than the host address.

Because a user of a network device will tend search for resources related to a geographic location in which the user (and, by extension, the network device) is located, events obtained from the network device, for example, search queries received from the network device and search results identified in response to the search queries can be used to estimate the geographic location of the device. A user may include references to geographic locations in search queries, such references being either explicit (for example, “Paris, France”) or implicit (for example, “The Eiffel Tower”). Such references can serve as an indicator of the geographic location of the network device with which the user provides the query. However, a reference to a geographic location in a query, in and of itself, does not establish that the user is in that location. For example, not all searches that include “Paris, France” will be from users in Paris, France. But, a search for “plumber Paris France” is likely to be by a user in Paris, France. This can also be the case for other events obtained from network devices apart from search queries, for example, for example, map queries for locations near a particular address.

The term “event” will be used to refer to patterns of information obtained from a network device. For example, as described above, an event can be a query received from the device, including a search query (e.g., “plumbers Paris”), a map query (e.g., map of a particular address in Paris), or a route query (e.g., driving directions from Paris to Nice). Other examples of events include settings in network applications observed at another network device or communicated to another network device (e.g., language settings, time zone or region settings, or settings in social networks). In addition, events can include information regarding one or several web pages, e.g., Uniform Resource Locators (URLs) of these web pages, visited by a network device and communicated to or observed by another network device. In another example, an event can include information associated with one or several cookies stored on the network device retrieved by another network device, or information generated from one or several cookies. In addition, events can include a posting or a setting in a social network or information derived from these events. All such events described can include implicit or explicit information related to the geographical location of the device.

This specification describes example implementations of a geo-location system configured to use information, including network addresses assigned to the network devices and events obtained from network devices, to identify groups of network devices that are likely to be located in the same or nearby locations. The geo-location system can determine an estimate of the geographical location of the group of devices, for example, a probability distribution that the group of client devices is distributed across a set of geographic locations.

The system, and other systems described in this specification, can be implemented on one or more computers located in one or more locations. A system of one or more computers can be configured to perform particular actions or operations by virtue of having software, firmware, hardware, or a combination of them installed on the system that in operation causes the system to perform the actions or operations. Similarly, one or more computer programs can be configured to perform particular actions or operations by virtue of including instructions that, when executed by data processing apparatus, cause the apparatus to perform the actions or operations.

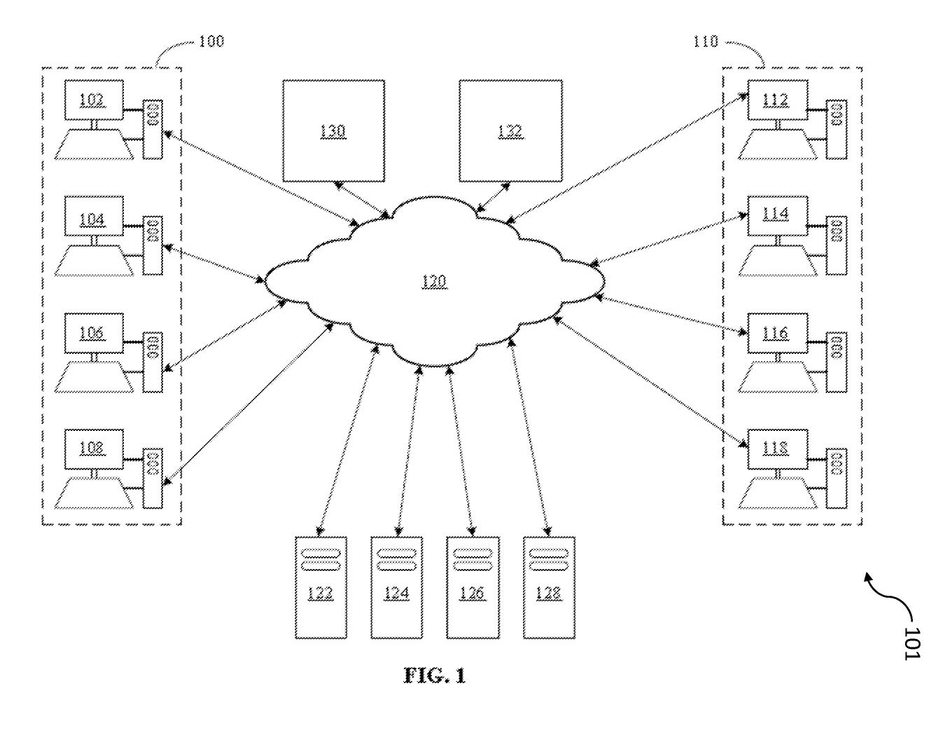

FIG. 1 shows multiple client devices and computer systems coupled to a network 100. Even though FIGS. 1 to 5 show client and host devices in a client-host network, the techniques described in this specification can also be used for other kinds of network devices. For example, routers, bridges, hubs, switches or repeaters can be clustered and/or an estimate of their geographical location can be determined using the processes described in reference to FIGS. 1 to 5.

A first group 101 of client devices (including client devices 102, 104, 106, and 108) and a second group 110 of client devices (including client devices 112, 114, 116, and 118) are coupled to a network 120 (for example, the Internet). In addition, multiple host computer systems (including hosts 122, 124, 126, and 128) are coupled to the network 120. The host computer systems store resources. Each resource has associated with it a unique network identifier, for example, a Uniform Resource Locator. Users of client devices (e.g., the client devices included in the first group 101 of client devices or the second group 110 of client devices) can access the resources either directly using the unique identifiers, or by searching for the resources, for example, by providing queries to search engines that identify resources that satisfy such queries and accessing resources identified by the search engines through unique identifiers provided by the search engines.

A historical data store 130 stores information associated with each of the multiple client devices (e.g., the client devices included in the first group 101 of client devices or the second group 110 of client devices). As described below, the information includes network addresses assigned to the client devices and events obtained from the client devices. Optionally, the historical data store 130 can store cookies stored on the client devices, and additional information.

The client devices transmit their respective network addresses in request messages they send to a search engine system for accessing or searching for resources stored on the host computers. The historical data store 130 stores the respective IP addresses of the client devices. In addition, the historical data store 130 also stores events obtained by the search system from the client devices. For example, when users of the client devices submit queries that include references to geographic locations to search engines (e.g., map search engines, text search engines, or driving direction search engines) of a search system, the system or the search engines store the queries or text from the queries in the historical data store 130. The search engines can also store, in the historical data store 130, information from search results provided in response to the search queries. In particular, the search engines can store information associated with the search results that the user subsequently selects, including geographical information that indicates locations associated with the search results. For example, a user can receive in response to a search query “restaurant Springfield” search results which relate to restaurants in different cities named Springfield. Subsequently, the user may select one or several of the search results relating to restaurants in Springfield, Ill. Therefore, the user's selection can be taken as an indication of an actual location of the user. In other examples, the time the user spends on one more webpages linked to a search result the user received in response to a search query can be stored in data store 130. The longer the user stays on the one or more webpages, the more likely the user might be located at a geographical location the particular search result is associated with.

Upon receiving a query from the client device 102, a search engine can identify resources that satisfy the query, generate search results that include URLs that address the resources together with snippets that include text contained in the resources, and transmit the information to the client device 102 for display to the user. The user of the client device 102 can select one or more of the displayed resources, for example, by clicking on corresponding search results in a search results web page. The selection information can be transmitted by code in the search results web page (e.g., JavaScript code) to the search engine. In this manner, the search engine can store, in the historical data store 130, search queries, search results provided to the client devices in response to those queries, and particular resources in the search results selected by the users of the client devices, as well as subsequent actions taken by users of the client devices. In some cases, users will have installed a search engine toolbar or other software component on the client device, and have given permission for the component to gather the foregoing kinds of information and transmit the information to a server of the search system for storage in the historical data store 130.

For situations in which the systems (e.g., search engines or geo-location system 132) discussed here collect personal information about users, the users may be provided with an opportunity to opt in/out of programs or features that may collect personal information (e.g., information about a user's preferences or a user's current location). In addition, user information that is used to identify unique users, unique network addresses or other user-related history can be anonymized so that the privacy of users is protected. Encryption and obfuscation techniques can also be used to protect the privacy of users.

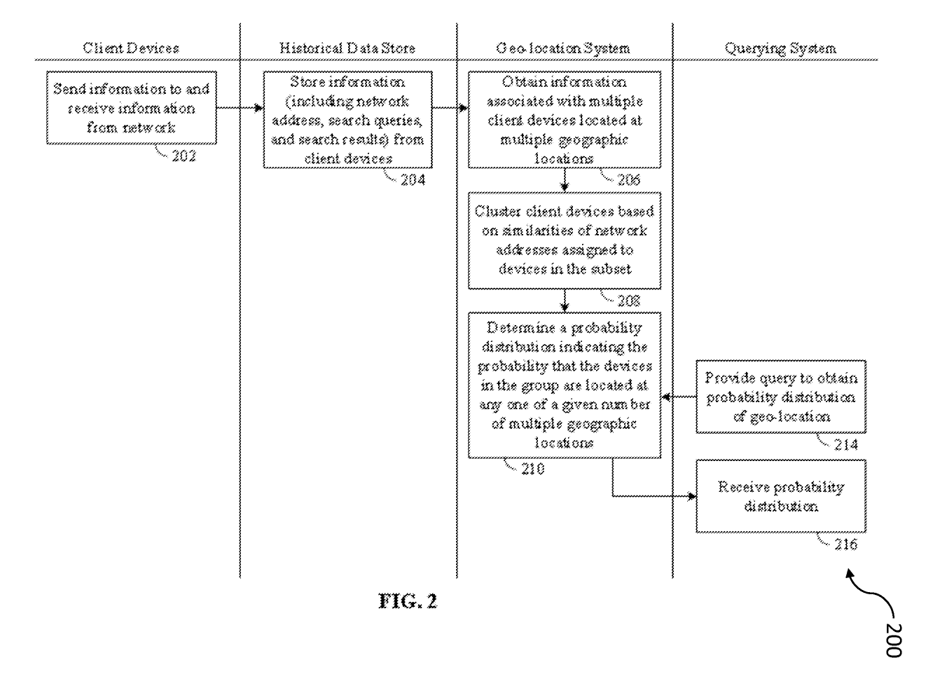

A geo-location system 132 is coupled to the historical data store 130, e.g., through the network 120. As described below, the geo-location system 132 can be configured to cluster groups of devices based on their network addresses, and/or to determine an estimate of one or more geographic locations in which client devices that have been clustered by IP address are physically located (e.g., client devices in group 100), based on some or all of the information stored in the historical data store 130. In particular, the geo-location system 132 can be configured to provide a location probability distribution for client devices in an IP address cluster that indicates the probability that any device in the cluster is located at one of several possible geographic locations. The actions performed by the geo-location system 132 are described with reference to FIGS. 2-4.

FIG. 2 is a flow diagram of an example process 200 for determining location probability distributions for a plurality of client devices based on the IP addresses of the client devices. The process 200 includes two sub-processes, i.e., clustering client devices based on similarities of their network addresses, and determining the location probability distributions for client devices in each identified cluster, where the location probability distributions represent the probability that a client device in the cluster is located at any one of multiple possible geographic locations. Note, however, that each sub-process can be performed independently from the other. Thus, in some implementations the geo-location system performs a clustering sub-process (at 208) without determining an estimate of the geographical location of the client devices 210 in a given cluster. In other implementations, the geo-location system 132 determines location probability distributions for a group of devices that have been previously clustered by the geo-location system 132 or another system.

The process 200 is described using IP addresses; however, the process 200 can also be performed using other kinds of network addresses. As described above, client devices send and receive information over the network 120 (at 202). A search engine or other network application can store, in historical data store 130, some or all of the received information including network addresses and events obtained from the client devices (e.g., search queries, search results, selections from among search results, and location information associated with the search queries and search results) (at 204). Each of the events obtained from the client devices can include a time stamp. The time stamps can include the date and time at which network addresses were transmitted and events where obtained (e.g., times at which search queries were submitted or search results were accessed or URLs were visited). The geo-location system 132 obtains the information from the historical data store 130. In some implementations, the geo-location system 132 can obtain the information (at 206) and filter the information in the historical data store 130 based on various criteria, for example, to avoid using portions of the information that will negatively affect the determination of location probability distributions.

In certain instances, for each client device, the system 132 obtains a set of client device specific data that can include a network address of the client device, a cookie received from the client device, events obtained (e.g., queries obtained and responses to those queries) from the client device over a given time period (e.g. 21 days), and time stamps indicating a time that each event was transmitted. The client device specific data can be a subset of the information stored in the historical data store 130.

As indicated above, information stored in the historical data store 130 can be filtered based on various criteria. For example, the time period in which events were obtained or received can be used as a filtering criterion. In addition or in combination with the time period, the filtering criterion can include removing events that do not reference geographic locations. In addition, duplicate instances of events can also be excluded. However, in other implementations, duplicates are not excluded as they can have predictive power for a device's geographical location. By filtering information obtained from the client devices, the geo-location system 132 can obtain a set of client device specific data from the historical data store 130.

The geo-location system 132 can cluster client devices and events associated with client devices based on similarities of network addresses assigned to the devices (at 208). Generally, similar IP addresses tend to be assigned to client devices that are located in the same geographic area. For example, an ISP can assign similar IP addresses (e.g., IP addresses having the same subnetwork address) to all client devices in all or a portion of a city. Over time, the ISP can dynamically re-allocate those IP addresses among the client devices in the geographic area. In addition, at times, the ISP can re-allocate a first range of IP addresses assigned to a first set of client devices in a first geographic area to a second set of client devices located in a second geographic area, and re-allocate another range of IP addresses to the first set of client devices in the first geographic area. The geo-location system 132 is configured to determine regions in IP address space (i.e., IP address ranges) in which IP addresses within a given IP address range are dynamically assigned and re-assigned to a group of client devices within a specified time period, for example, a time period of one day or several days.

Network addresses that are re-allocated to a group of client devices in this manner can be presumed to be allocated to client devices that are located within the same geographic area (i.e., a set of one or more geographical locations). The geo-location system 132 can identify a range of IP addresses that are dynamically allocated to a group of client devices, such that over time, the client devices within the group only receive allocated IP addresses that are within the identified range. Alternatively, or in addition, the geo-location system 132 can identify two different ranges of IP addresses that are assigned to the same group of client devices at different times, indicating that an ISP migrated the client devices from a first of the two IP address ranges to a second of the two IP address ranges.

To do so, the geo-location system 132 can track particular client devices based on data uniquely identifying the client devices, such as cookies stored on or associated with the client devices or MAC addresses associated with the client devices. By tracking these unique identifiers over time, the geo-location system 132 can determine one or more IP addresses associated with a particular client device during the predetermined time period. The system 132 first identifies client devices (e.g., based on unique cookies) that have migrated from a first IP address to a second IP address during a predetermined time period using the client device's network address and timestamp information as recorded in the historical data store 130. Next, the system 132 creates a matrix of rows (“from IP address”) and columns (“to IP address”), and includes in the cells of the matrix an identifier of each particular client device whose IP address has migrated from a “from IP address” to a “to IP address.” The resulting matrix will generally be in a block diagonal form, or capable of being transformed to a block diagonal form using conventional matrix manipulation techniques.

The system 132 can identify blocks of cells on the diagonal of this matrix, and within each such block, a group of client devices that have been dynamically assigned and re-assigned IP addresses that are associated with each block (i.e., a range of IP addresses determined by the size of the block on the diagonal of the matrix). Such client devices form a group, (also known as an IP address cluster or allocation pool) that is likely to be located in the same geographic area. The geo-location system 132 can identify these IP address clusters and store this information. The system 132 can also identify blocks of cells that are located off the diagonal of the matrix, and for each such block, a group of client devices that have been migrated from a first IP address range to a second IP address range, where the first and second IP address ranges are determined by the particular IP addresses included in the off-diagonal block. Again, such client devices are likely to be located in the same geographic area. The system 132 can again identify these groups of IP addresses and store this information.

An illustration of a matrix as described above (in block form to indicate relevant IP address blocks) is shown in Table 1 below. The data in the table indicates that at some point in time during a predetermined time period, the IP addresses of client devices 102, 104, 106, and 108 have been dynamically allocated within and migrated between a first IP address range (e.g., IPR1) and a second IP address range (e.g., IPR2). Moreover, the table shows that during the same period of time, the IP addresses of client devices 112, 114, 116, and 118 have been dynamically re-allocated within a third IP address range (IPR3). Other devices (not shown) were dynamically allocated during that period of time to IP addresses within a fourth IP address range (IPR4).

TABLE 1

| | To IPR1 | To IPR2 | To IPR3 | To IPR4 |
|---|---|---|---|---|
| From IPR1 | 102, 104, 106, | 102, 104, 106, | | |
| | 108 | 108 | | |
| From IPR2 | | 102, 104, 106, | | |
| | | 108 | | |
| From IPR3 | | | 112, 114, 116, | |
| | | | 118 | |
| From IPR4 | | | | Other client |
| | | | | devices |

In some implementations, for each block diagonal or block off-diagonal group identified from the matrix, the geo-location system 132 can determine a location probability distribution for the client devices in the group. The location probability distribution indicates the probability that a client device in the group is located at any one of a given number of possible geographic locations (at 210). Alternatively, the location probability distribution gives the most likely geographic distribution of the client devices in the group. As noted above, however, the determination of a location probability distribution for the client devices in an IP address cluster or allocation pool can be performed by the geo-location system 132 independently of determining the IP address cluster or allocation pool. For example, a group of devices can have been previously grouped together in an IP address cluster or allocation pool by another system. The geo-location system 132 can receive data identifying this block of IP addresses and carry out the methods described below to determine the location probability distribution for this group of devices.

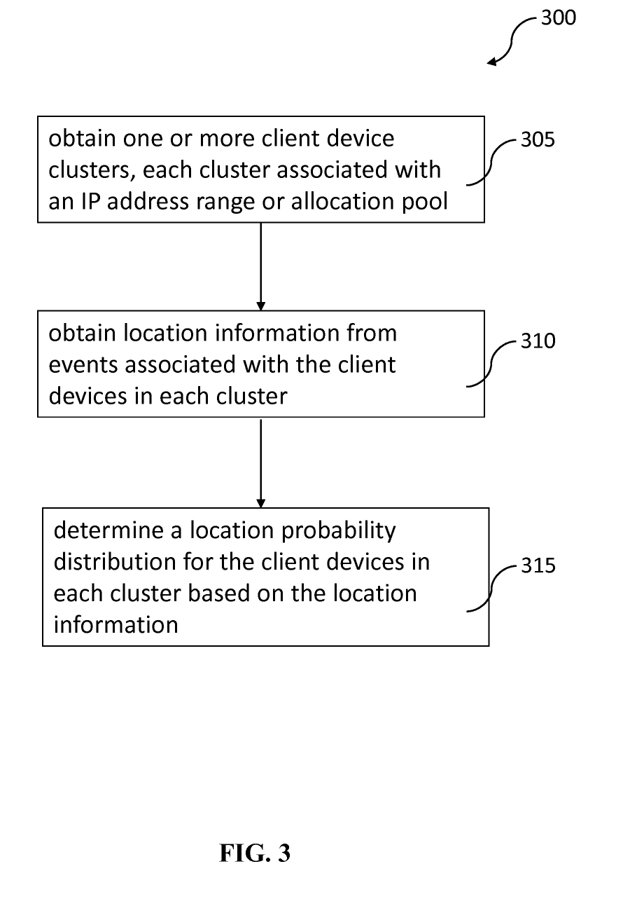

FIG. 3 is a flowchart of a process 300 for determining a location probability distribution for client devices within a given IP address cluster or allocation pool. The process 300 can be performed by a system of one or more computers configured to perform the operations described in this specification. The process 300 first identifies or receives an identification of a group of client devices that are within an IP address cluster or allocation pool (step at 305). Such a group of client devices is likely to be located in the same general geographical area, e.g., in an area serviced by an ISP that controls the dynamic assignment of IP addresses to client devices in the group. However, other techniques can also be used to identify the group of client devices. For instance, information identifying the group of client devices can be obtained from another system, or can be based on an IP address subnet mask since client devices having similar IP addresses are often located near one another.

Next, for each such IP address cluster or allocation pool, the process 300 obtains from the historical data store 130 a plurality of events that are associated with the client devices in the cluster and that identify one or more geographical locations (at 310). The plurality of events can include, for example, events that identify geographical locations in search queries or driving directions. For instance, when a search query such as “plumbers Paris,” is obtained from a client device, process 300 can infer that the device is located in or near Paris. Similarly, when the events obtained from a client device include a plurality of driving directions with the same “from” field (e.g., driving directions from Paris to Nice and driving directions from Paris to Montpellier), process 300 can infer that the location of the “from” field is associated with the client device. Other events can also be used to identify or infer locations that may be associated with the client devices in the cluster, including for example, Global Positioning System (GPS) coordinates, a viewport showing a map, or a language associated with a query or with a search result provided in response to the query.

The process 300 next determines, based on the locations identified from the events obtained from the client devices in the group, a location probability distribution for the client devices. The location probability distribution gives the probability that any client device in the group is located at any one of multiple geographic locations identified that have been identified from the events (at 315). Processes by which the location probability distribution is subsequently refined are described more fully below.

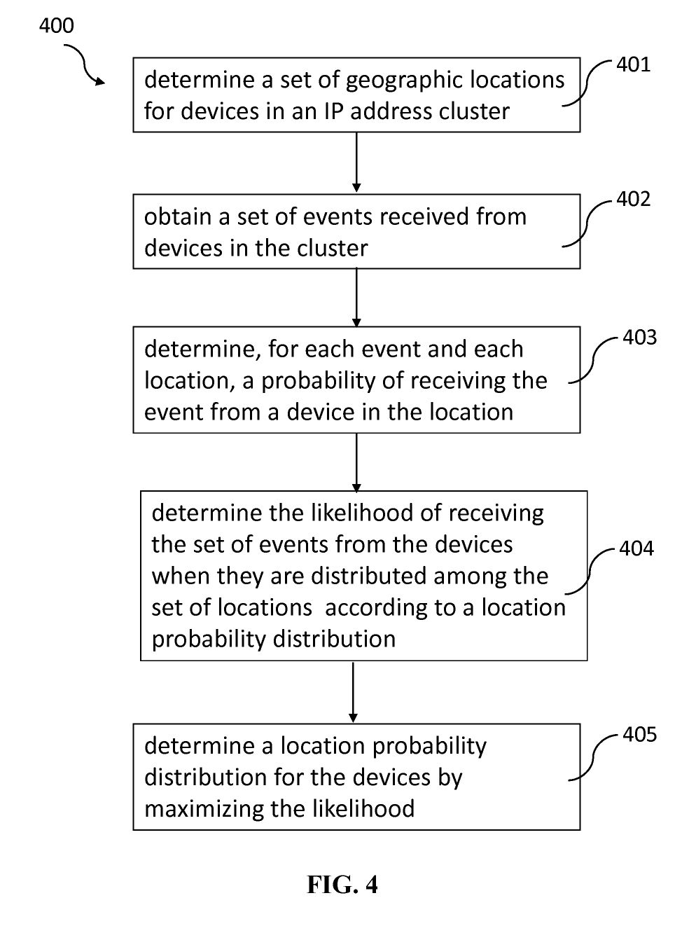

FIG. 4 is a flowchart of an example process 400 for determining a probability distribution representing the probability that the client devices in an IP address cluster or group are distributed across multiple geographic locations. The process 400 can be performed by a system of one or more computers configured to perform the operations described in this specification. First, the geo-location system 132 determines a set of geographical locations (401). The set of the geographical locations can be predetermined (e.g., the geographical locations in a particular geographical region of interest). Alternatively, the set of geographical locations can be determined from geographical information identified in a set of observed events received from the devices in the group, as described above in reference to FIG. 3. The geographical locations form a set L of geographical locations having M members, where the j-th member is denoted with lⱼ.

Next, the system 132 obtains N events that have been observed from the group of client devices whose geographical location distribution is to be determined (at 402). The obtained events form a set of events E having N members, where the i-th member is denoted by evᵢ. Both N and M are natural numbers. The system 132 next determines, for each observed event and each geographic location, the probability P(evᵢ|lⱼ) that a given event, (e.g., the i-th event, evᵢ), has been observed from a client device at a given location (e.g., the j-th geographical location lⱼ) (at 403).

Probabilities such as these can be obtained, for example, by geocoding one or more IP addresses in the client device group or IP address cluster to a single location (e.g., San Francisco), identifying one or more events obtained from those IP addresses (e.g., queries, query results, driving directions, map viewports), and determining the probability or rate of occurrence of observing those events from that location. The one or more IP addresses can be a subset of the IP addresses in the IP address cluster. One or more subsets of IP addresses in the cluster can be mapped to different locations to obtain a plurality of locations for devices in the cluster, e.g., the plurality of locations lⱼ in the set L. The single location (e.g., lⱼ) determined for the one or more IP addresses in the j-th subset of the cluster can be determined from locations identified in events obtained from the data store 130 that are associated with those client devices. A method for making such a determination is described, for example, in U.S. patent application Ser. No. 11/851,271, filed on Sep. 6, 2007 and entitled “Network Address Geographic Location Mapping for Search Queries,” which is incorporated herein by reference in its entirety. This step of finding the probabilities P(evᵢ|lⱼ) can be repeated for all events e in the set of events E and all geographical locations 1 in the set of geographic locations L. Alternatively, the probabilities P(evᵢ|lⱼ) can be previously known and stored in a database, and the system 132 can request them for an obtained event and location from this database.

Next, the system 132 forms an expression for the likelihood that the observed set of events is obtained from a group of client devices distributed according to a location probability distribution X(l) (at 404). This likelihood can be expressed by the conditional probabilities obtained in step 403 and the location probability distribution X(l) of the group of client devices. Next, the system 132 can determine the location probability distribution X(l) for the group of devices by maximizing this likelihood expression (405).

For example, the likelihood D(E|X) that the observed set of events was obtained from a group of devices distributed according to a location probability distribution X(l), can be expressed as:

$$\begin{matrix}log D ( E \vert X ) = log {Π}_{ev ∈ E} D ( ev \vert X ) \\ = {\sum }_{ev ∈ E} log ( D ( ev \vert X ) ) \\ = {\sum }_{ev ∈ E} log {\sum }_{l ∈ L} X ( l ) P ( ev \vert l ) .\end{matrix}$$

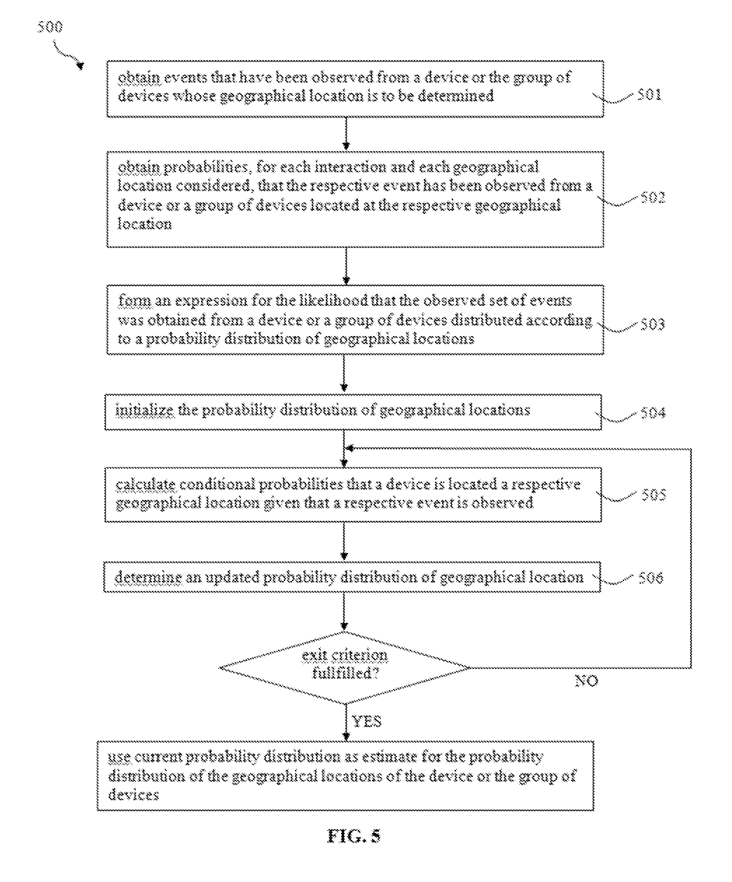

A location probability distribution X(l) that maximizes this expression is sought. This problem can be solved by statistical methods, for example, using an expectation-maximization algorithm as described below in reference to FIG. 5. Alternatively, a gradient descent algorithm can also be used to determine a location probability distribution X(l) that maximizes this expression, or a Markov chain Monte Carlo algorithm.

To obtain a location probability distribution that maximizes the likelihood function using an expectation maximization algorithm, the likelihood function is re-written in terms of a plurality of latent variables q(l|ev). These latent variables, which are unknown, indicate the probability that a device is at a location/given that an event e was received from the device. The likelihood expression can be rewritten using these latent variables q(l|ev) as:

$$log D ( E \vert X , q ) = {\sum }_{ev ∈ E} {\sum }_{l ∈ L} q ( l \vert ev ) log X ( l ) P ( ev \vert l )$$

This likelihood expression can be maximized as shown in FIG. 5. First, the system 132 initializes the location probability distribution X(l) (at 504). For example, the initial location probability distribution can be obtained as described above in reference to FIG. 3. Alternatively, the initial location probability distribution can be a flat distribution of locations that have identified from events observed from the client devices in the cluster. Next, the system 132 performs an iterative procedure, which includes first calculating expectation values for the latent conditional probabilities q(l|ev) for each event in the set of events E and each location in the set of locations L. The expectation values for the latent conditional probabilities q(l|ev) can be calculated from the latest estimate of the location probability distribution X(l) (at 505) according to:

$$q ( l \vert ev ) = P ( ev \vert l ) Xt ( l ) {l}^{′} ∈ LP ( ev \vert {l}^{′} ) Xt ( lq ( l \vert ev ) = \frac{P ( ev \vert l ) {X}^{t} ( l )}{{\sum }_{{l}^{′} ∈ L} P ( ev \vert {l}^{′} ) {X}^{t} ( {l}^{′} )} .$$

In a maximization step that follows the expectation step, the system can use the updated expectation values for the conditional probabilities q(l|ev) to determine an updated location probability distribution X^{t+1}(l) (at 506) as follows:

$${X}^{t + 1} ( l ) = \frac{{\sum }_{ev ∈ E} q ( l \vert ev )}{{\sum }_{{l}^{′} ∈ L} {\sum }_{ev ∈ E} q ( {l}^{′} \vert ev )} .$$

In the following expectation step, the system uses the updated location probability distribution X^{t+1}(l) to obtain an updated set of expectation values for the latent conditional probabilities q(l|ev), which then are used to obtain another update for the location probability distribution X^{t+2}(l) and so on.

This iterative procedure can be continued until an exit criterion is fulfilled. For instance, the exit criterion can be a determination that the probabilities in the location probability distribution are converging. This can be determined, for example, by determining that the change in the probabilities between two iterations is lower than a predetermined threshold, or that the change in the last m iterations was lower than a predetermined threshold. In addition, the exit criteria can include determining that a maximum number of iterations has occurred.

Once the exit criterion is fulfilled, the system 132 can output the location probability distribution determined from the last iteration as an estimate of the location probability distribution of the group of devices. If the system 132 exits the iteration because a maximum number of iterations has occurred without showing a convergence of the probabilities in the location probability distribution, the system 132 can return an error message rather than a location probability distribution.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, for example, a machine-generated electrical, optical, or electromagnetic signal, which is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (for example, multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, for example, an FPGA (field programmable gate array) or an ASIC (application-specific integrated circuit). The apparatus can also include, in addition to hardware, code that creates an execution environment for the computer program in question, for example, code that constitutes processor firmware, a protocol stack, a database management system, an operating system, a cross-platform runtime environment, a virtual machine, or a combination of one or more of them. The apparatus and execution environment can realize various different computing model infrastructures, for example web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (for example, one or more scripts stored in a markup language document), in a single file dedicated to the program in question, or in multiple coordinated files (for example, files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, for example, an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be coupled to receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a Global Positioning System (GPS) receiver, or a portable storage device (for example, a universal serial bus (USB) flash drive), to name just a few. Devices suitable for storing computer program instructions and data include all forms of non-volatile memory, media and memory devices, including by way of example semiconductor memory devices, for example, EPROM, EEPROM, and flash memory devices; magnetic disks, for example, internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, for example, a CRT (cathode ray tube) or LCD (liquid crystal display) monitor, for displaying information to the user and a keyboard and a pointing device, for example, a mouse or a trackball, by which the user can provide input to the computer. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of digital data communication, for example, a communication network. Examples of communication networks include a local area network (“LAN”) and a wide area network (“WAN”), an inter-network (for example, the Internet), and peer-to-peer networks (for example, ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (for example, an HTML page) to a client device (for example, for purposes of displaying data to and receiving user input from a user interacting with the client device). Data generated at the client device (for example, a result of the user interaction) can be received from the client device at the server.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1-8. (canceled)

9. A method performed by a data processing apparatus, the method comprising:
determining a first set of Internet Protocol (IP) addresses allocated to network devices, wherein each network device hosts a respective cookie at a first point in time;
determining a second set of IP addresses allocated to the network devices hosting the same respective cookies at a second point in time later than the first point in time; and
clustering in a first group network devices based on similarities in a pattern of reallocation processes of IP addresses assigned to the network devices in the group at the first and second points in time, wherein the first and second sets of IP addresses include a plurality of shared IP addresses, and wherein at least one of the shared IP addresses is re-allocated to a different network device at the second point in time.

10. The method of claim 9, further comprising:
determining a third set of IP addresses allocated to the network devices hosting the plurality of cookies at a third point in time later than the first and second points in time; and
clustering in a second group the network devices hosting the plurality of cookies based on similarities in a pattern of reallocation processes of the IP addresses assigned to the network devices in the second group at the first, second and third points in time.

11. The method of claim 9, further comprising:
obtaining a geographical location estimate for the network devices in the first group based on information associated with at least one of the network devices in the first group.

12. The method of claim 11, wherein obtaining a geographical location estimate includes: determining a probability distribution including a probability for each of the plurality of geographic locations that the network devices in the first group are located at the geographic location.

13. The method of claim 9, further comprising:
re-clustering a sub-group of devices of the first group of network devices based on a difference in a pattern of reallocation processes of the sub-group of the network devices and the remaining network devices of the first group of network devices.

14. The method of claim 9, wherein clustering a group of network devices includes:
identifying network devices whose IP address have been re-allocated in the first set of IP addresses between the first and second points in time; and
clustering the identified network devices whose IP address have been reallocated in the first group of network devices.

15. The method of claim 14, further comprising:
creating a matrix and including in the cells of the matrix an identifier of each particular network device whose IP address has been re-allocated in the first set of IP addresses or the second set of IP addresses between the first and second points in time; and
wherein the network devices are identified using the matrix.

16. The method of claim 15, further comprising: transforming the matrix in a block diagonal form.

17. The method of claim 16, wherein identifying network devices includes identifying the network devices associated with IP addresses included in a cell on a diagonal of the matrix.

18. The method of claim 10, wherein clustering a group of the network devices includes:
identifying network devices whose IP address have been re-allocated from the first set of IP addresses to the second set of IP addresses between the first and second points in time; and
clustering the network devices whose IP address have been re-allocated in a third group of network devices.

19. The method of claim 18, further comprising:
creating a matrix and including in the cells of the matrix an identifier of each particular network device whose IP address has been re-allocated in the first set IP addresses or the second set of IP addresses between the first and second points in time; and
wherein the network devices are identified using the matrix.

20. The method of claim 19, further comprising: transforming the matrix in a block diagonal form.

21. The method of claim 20, wherein identifying network devices includes identifying the network devices associated with IP addresses included in a cell off a diagonal of the matrix, such that the cell is not located within a diagonal of the matrix.

22. A computer-implemented method for providing geolocated content to network devices, the method comprising:
transmitting, at a first point in time, first messages from a plurality of network devices,
transmitting, at a second point in time subsequent to the first point in time, second messages from the plurality of network devices,
wherein:
a first and a second sets of Internet Protocol (IP) addresses are allocated to the plurality of network devices at the first point in time and the second point in time, respectively, with some of the IP addresses in the first set being re-allocated to different ones of the plurality of network devices at the second point in time,
each of the first messages and the second messages indicates (i) the IP address of the corresponding network device and (ii) identifying information for the network device; and
receiving, at one of the plurality of network devices, content corresponding to a probable geolocation of the network device, wherein several of the plurality of network devices form a cluster based on similarities in a pattern of reallocation of IP addresses between the first point in time and the second point in time, and wherein the probable geolocation is based on belonging to the cluster.

23. The method of claim 22, wherein the probable geolocation is a first probable geolocation, the cluster is a first cluster, and further comprising:
transmitting, at a third point in time subsequent to the second point in time, third messages from the plurality of network devices,
wherein:
a third set of IP addresses is allocated to the plurality of network devices at the third point in time; and
receiving, at one of the plurality of network devices, content corresponding to a second probable geolocation of the network device, wherein several of the plurality of network devices form a second cluster based on the first and second sets of IP addresses including a plurality of shared IP addresses and the second and third sets of IP addresses including a plurality of different IP addresses, and wherein the second probable geolocation is based on belonging to the second cluster.

24. The method of claim 23, further comprising:
receiving, at one of the plurality of network devices, content corresponding to a third probable geolocation of the network device, wherein several of the plurality of network devices form a third cluster based on the first, second, and third sets of IP addresses including a plurality of shared IP addresses, wherein at least one of the IP addresses in the second set is re-allocated to a different network device at the third point in time, and wherein the third probable geolocation is based on belonging to the third cluster.

25. The method of claim 22, wherein the probable geolocation is a first probable geolocation, and further comprising:
receiving, at one of the plurality of network devices, content corresponding to a second probable geolocation of the network device, wherein several of the plurality of network devices from a sub-group of the cluster of network devices based on first and second subsets of IP addresses of the respective first and second sets of IP addresses including a plurality of different IP addresses, and wherein the second probable geolocation is based on belonging to the sub-group.
